(19) United States
(12) Patent Application Publication
(10) Pub. No.: US 2012/0018418 A1
(43) Pub. Date: Jan. 26, 2012

(54) TEMPERATURE CONTROLLABLE SHOES

(76) Inventors: Todata R. SHANTHA, Stone Mountain, GA (US); Krishna V. SRINVASA, Dallas, GA (US); Shaam P. Sundhar, Princeton, NJ (US)

(21) Appl. No.: 13/249,532

(22) Filed: Sep. 30, 2011

(51) Int. Cl. B23K 37/00

(52) U.S. Cl. 219/482

(57) ABSTRACT

A temperature controllable shoe has a shoe portion with a plurality of peltier chips disposed along an inner portion of the shoe to control the temperature inside the shoe. The user selects a desired temperature. The peltier chips are placed against a heat sink in thermal contact to dissipate any unwanted heat. In one embodiment, a wireless control unit is provided to wirelessly control the temperature of the shoes. Because of the thermal properties of the peltier chips, they can be used to either provide heating or cooling depending on the current flow. In another embodiment, the user wears a battery pack that is connected with a wire to the shoe. In another embodiment, the battery is placed within the shoe. In one embodiment, indicator lights are provided to allow a user to visually ascertain the status of the shoe.

### BACKGROUND OF THE INVENTION

The history of the shoe is as long as the record of human activity itself. In order to protect their feet, leaves were used to wrap around the foot and tied on with twine. A more sturdy form of early foot protection used animal hide to protect the foot in what eventually became the “moccasin”. The sandal is the oldest and most common kind of foot protection and is still the most popular year round footwear worn in countries having warm climates.

In areas with colder climate, a more protective form of footwear is needed to not only protect the sole against damage, but to insulate from the cold, wet and snow. In the early times, skins and furs were used. Many solutions to this problem have been proposed and utilized to keep a person's feet warm and dry including thermal insulting materials and waterproof coatings. While these innovations have provided workable solutions to the problem, many people still feel uncomfortable in shoes and never seem to be pleased with the temperature of their feet. Older people in particular often feel that their feet are cold regardless of the temperature. There is a need for a shoe that is temperature controllable and maintains a constant comfortable temperature.

### SUMMARY OF THE INVENTION

A temperature controllable shoe has a shoe portion with a plurality of peltier chips disposed along an inner portion of the shoe to control the temperature inside the shoe. The user selects a desired temperature. The peltier chips are placed against a heat sink in thermal contact to dissipate any unwanted heat. In one embodiment, a wireless control unit is provided to wirelessly control the temperature of the shoes. Because of the thermal properties of the peltier chips, they can be used to either provide heating or cooling depending on the current flow. In another embodiment, the user wears a battery pack that is connected with a wire to the shoe. In another embodiment, the battery is placed within the shoe. In one embodiment, indicator lights are provided to allow a user to visually ascertain the status of the shoe.

Other features and advantages of the instant invention will become apparent from the following description of the invention which refers to the accompanying drawings.

### BRIEF DESCRIPTION OF THE DRAWINGS

FIG. 1 is a perspective view of a temperature controllable shoe according to an embodiment of the invention.

FIG. 2 is a cut-away side view of the temperature controllable shoe shown in FIG. 1.

FIG. 3 is a perspective view of the temperature controllable shoe shown in FIG. 1 with indicator lights.

FIG. 4 is a cut-away side view of the temperature controllable shoe shown in FIG. 3.

FIG. 5 is a cut-away side view of the temperature controllable shoe shown in FIG. 1 having an external power source.

FIG. 6 is a perspective view of the temperature controllable shoe shown in FIG. 5.

FIG. 7 is a perspective view of the temperature controllable shoe shown in FIG. 5.

FIG. 8 is a perspective view of a temperature controllable shoe having a remote control.

FIG. 9 is a perspective view of a temperature controllable shoe having a remote control.

FIG. 10 is a perspective view of a temperature controllable shoe according to an embodiment of the invention.

FIG. 11 is a rear view of a temperature controllable shoe according to an embodiment of the invention.

FIG. 12 is a cut-away side view of the temperature controllable shoe shown in FIG. 11.

FIG. 13 is a perspective view of a temperature controllable shoe according to an embodiment of the invention.

FIG. 14 is a perspective view of a temperature controllable shoe according to an embodiment of the invention.

FIG. 15 is a perspective view of a temperature controllable shoe having a remote control.

FIG. 16 is a rear view of a temperature controllable shoe according to an embodiment of the invention.

FIG. 17 is a cut-away side view of the temperature controllable shoe shown in FIG. 16.

FIG. 18 is a cut-away side view of a temperature controllable shoe shown according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

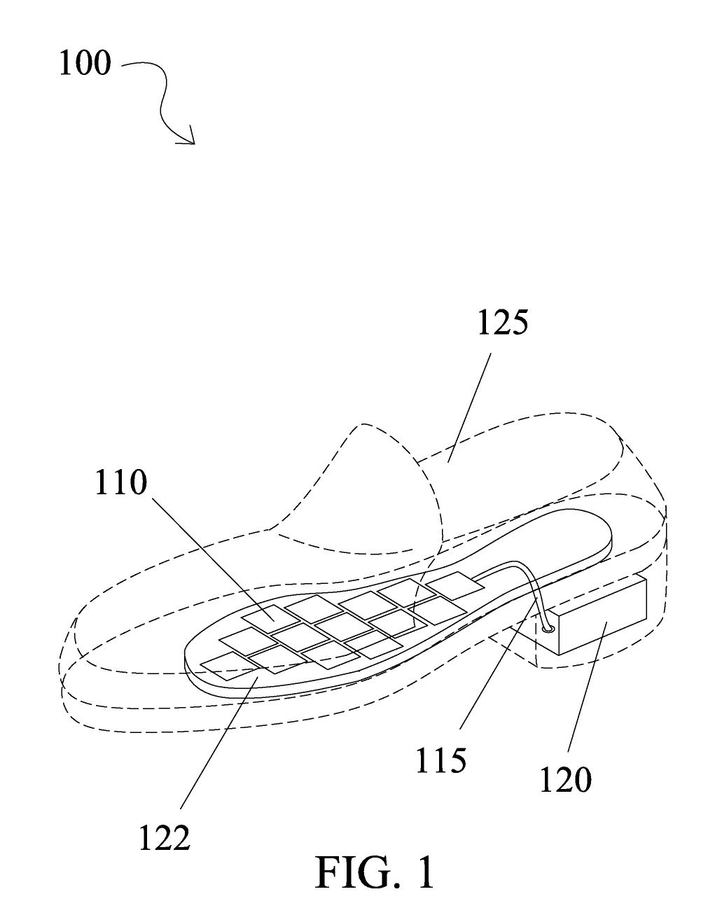

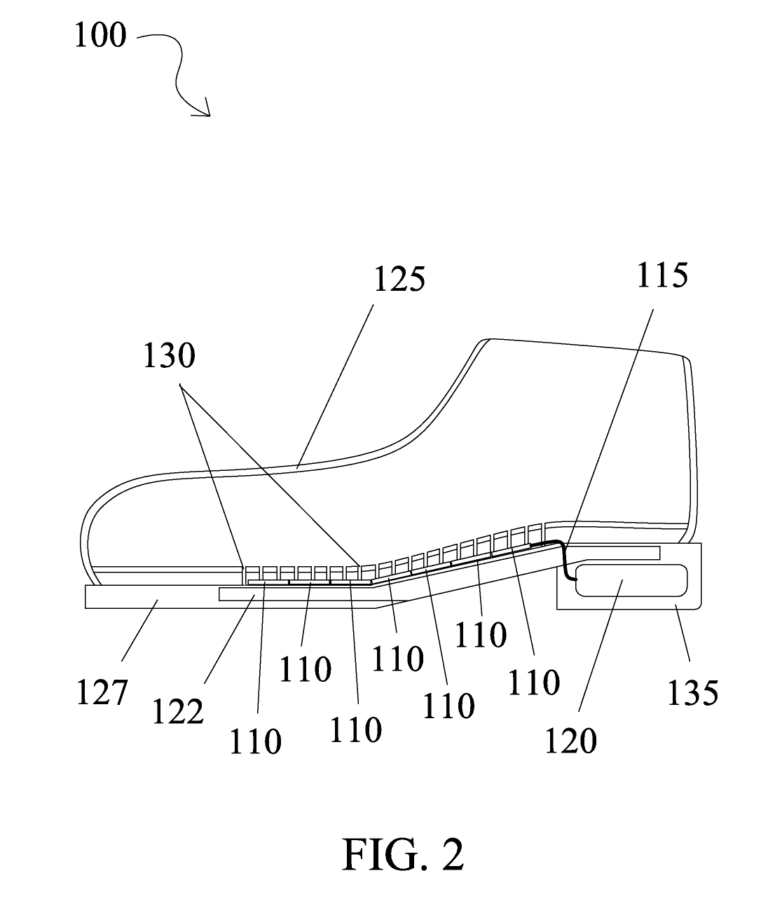

Referring to FIGS. 1 and 2, a temperature controllable shoe 100 is shown having a shoe portion 125 with a plurality of peltier chips 110 disposed within an outsole portion 127 of shoe 125. Peltier chips can produce heat or cold depending on the current flow. A heat sink 122 is provided to thermally dissipate the excess heat or cooling generated from peltier chips 110. A power source 120 is provided to energize peltier chips 110. In the embodiment shown, a battery 120 is disposed within a heel portion 135 of shoe 125. A power wire 115 delivers the current from batteries 120 to peltier chips 110. In this way, the temperature of the shoe can be adjusted to satisfy a particular user's comfort level. A protective sole portion has a plurality of ventilation channels 130 disposed therein to facilitate the thermal transfer of the desired heating or cooling from peltier chips 110.

Shoe 125 is shown as a representation of a typical shoe and is not meant to be limiting in the practice of the instant invention. It is clear from the description and drawings, that the instant invention may be used in any kind of a foot covering such as but not limited to boots, sandals, sneakers, athletic shoes, etc. without departing from the spirit of the invention.

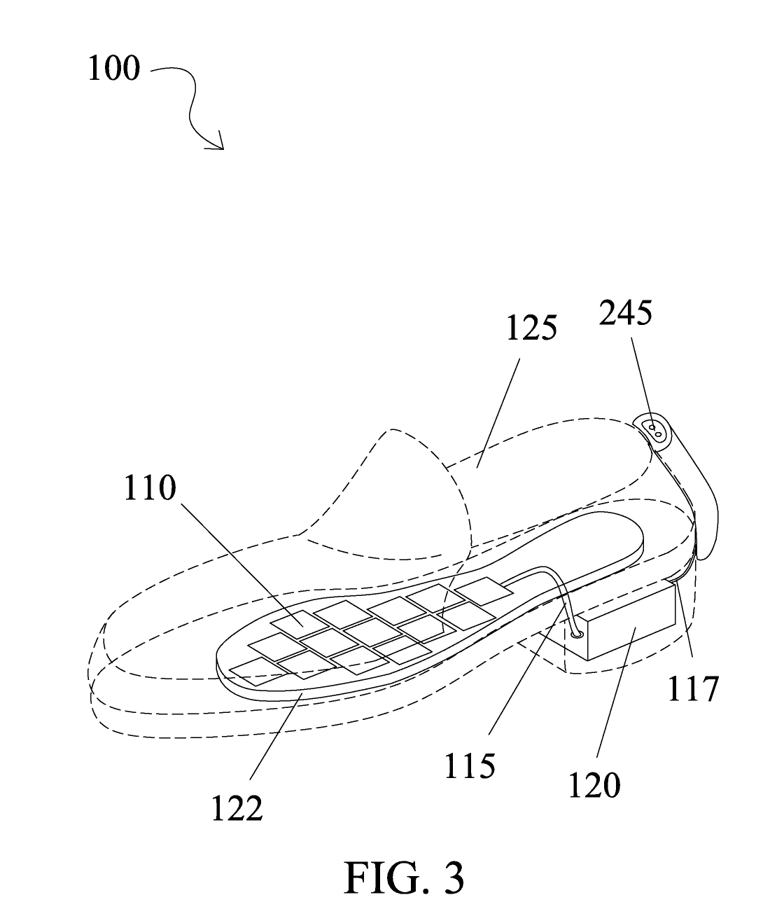

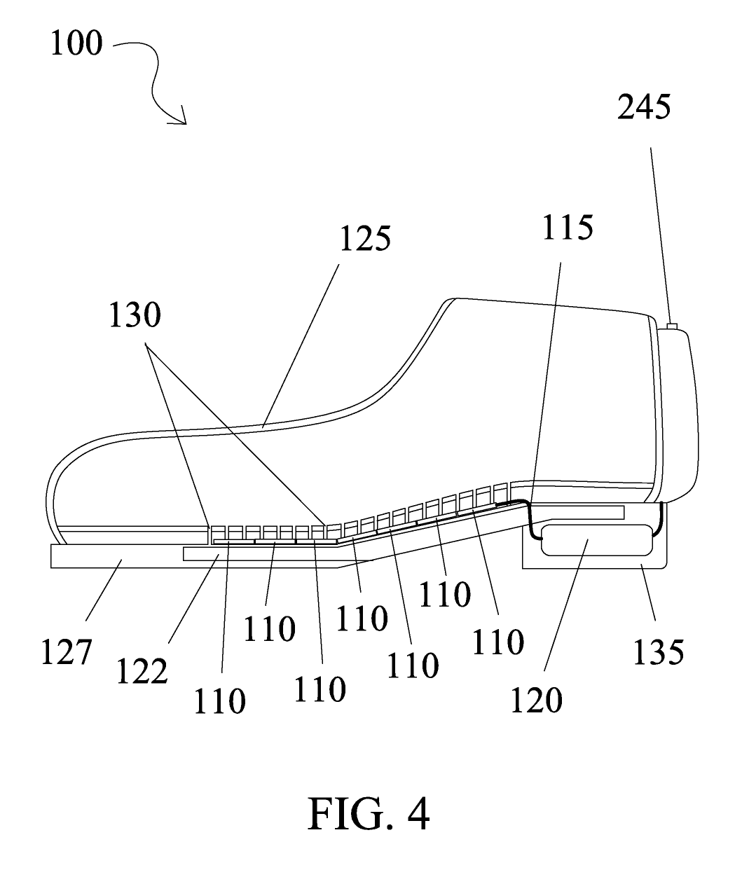

Referring now to FIGS. 3 and 4, a temperature controllable shoe 100 is shown have an indicator light assembly 245 disposed along a heel portion of shoe 125. A power wire 117 is provided to energize indicator lights. Although only two lights are shown, a red light for heat and a blue light for cool, it is understood that other lights could be provided such as power indicator, high, medium and low setting, etc. and provides visual feedback to the user about the operating state of the instant invention.

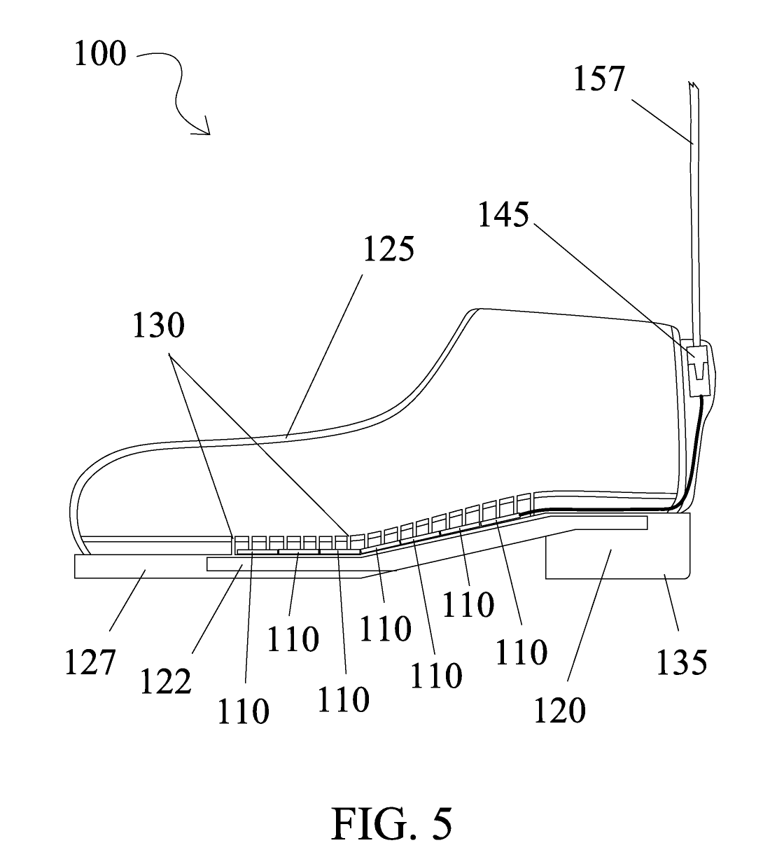

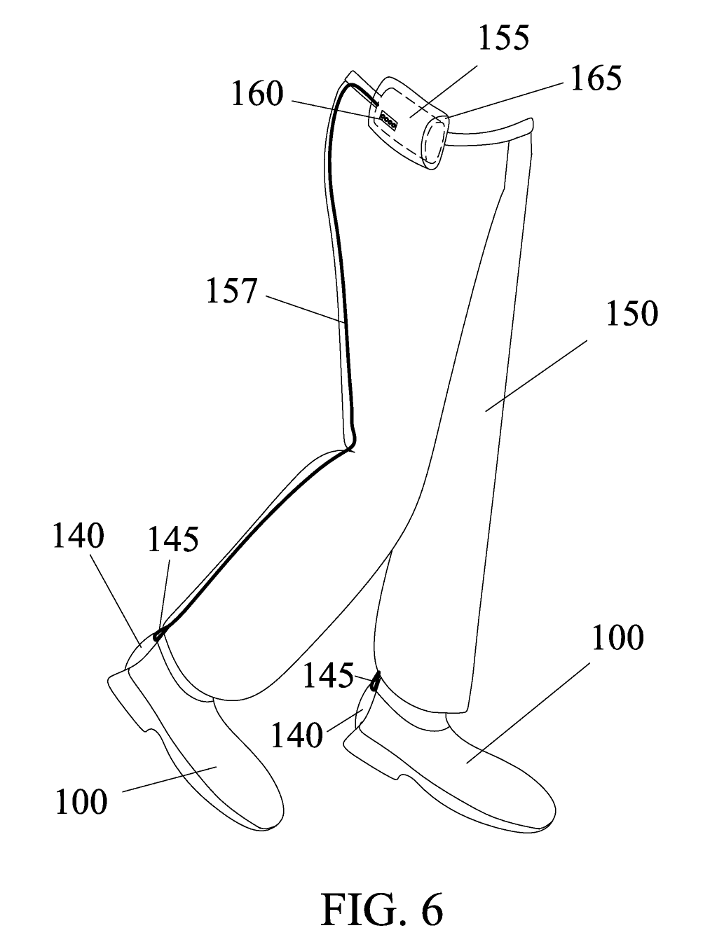

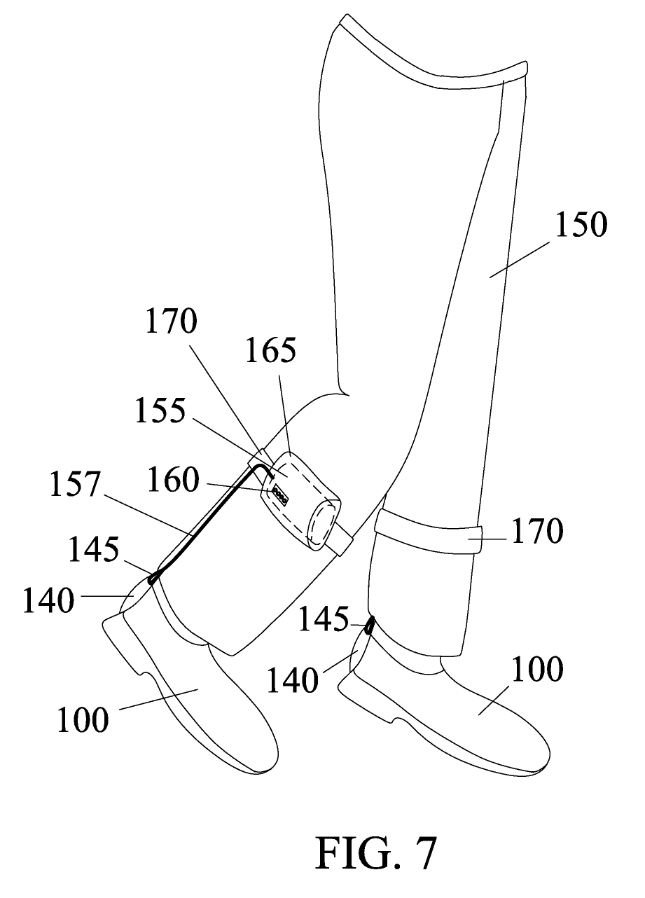

Now referring to FIGS. 5 through 7, temperature controllable shoe 100 is shown having an external power source 165 that is worn by a user 150, either around the waist (FIG. 6) or the ankle (FIG. 7). A power cable 157 is provided to electrically connect power source 155 to shoe 125. A plug 145 is provided to allow user to store shoe 125 without having to maintain connection with power source. This may also be used to connect power source 155 to a charging device (not shown) as is known in the art in an embodiment where power source 155 is rechargeable. Of course a disposable power source may be used. A control portion 160 is provided to allow the user to control the shoe. A power connector portion 140 is provided to protect and shield plug 145 from the elements and being damaged through wear.

In the embodiment shown in FIG. 6, a battery holder 165 is provided to allow the user to clip battery holder 165 to a belt. Of course other retaining mechanisms may be used such as clips, hook and loop fasteners, etc. In the embodiment shown in FIG. 7, an elastic band 170 is provided to allow the user to secure battery holder 165 to an ankle portion.

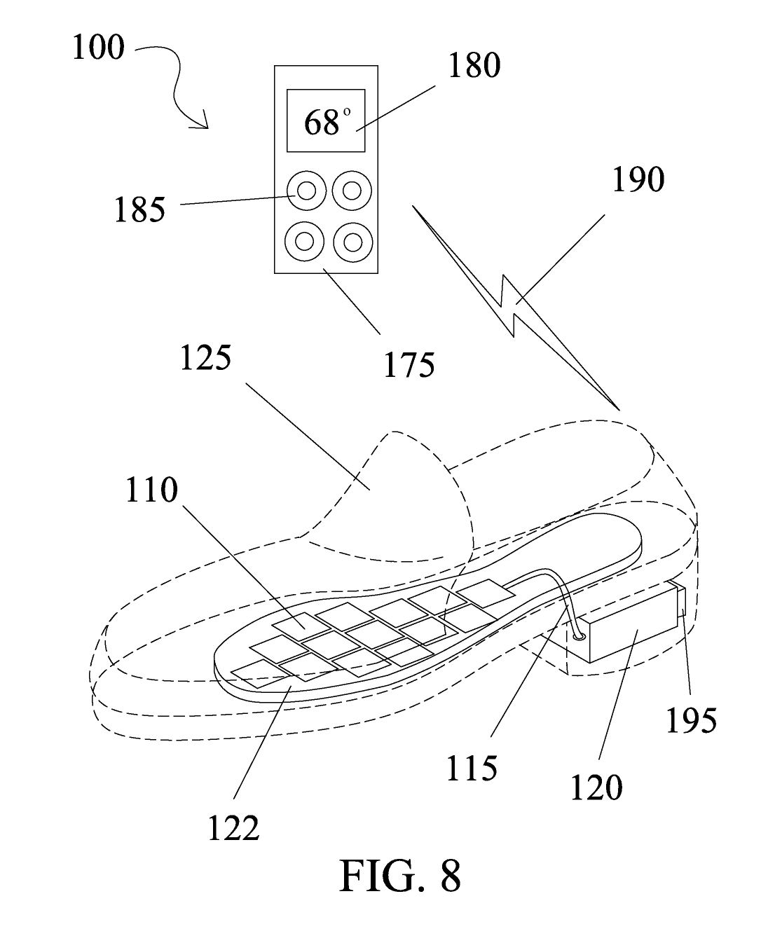

Referring now to FIG. 8, a wireless remote control 175 is provided to allow the user to adjust temperature 180 using control portions 185 and a wireless connection 190 such as infrared, RF (radio frequency, etc. as is known in the art. In the embodiment shown, the user selects a temperature 180 and a receiver 195 accepts the input and adjusts the temperature accordingly.

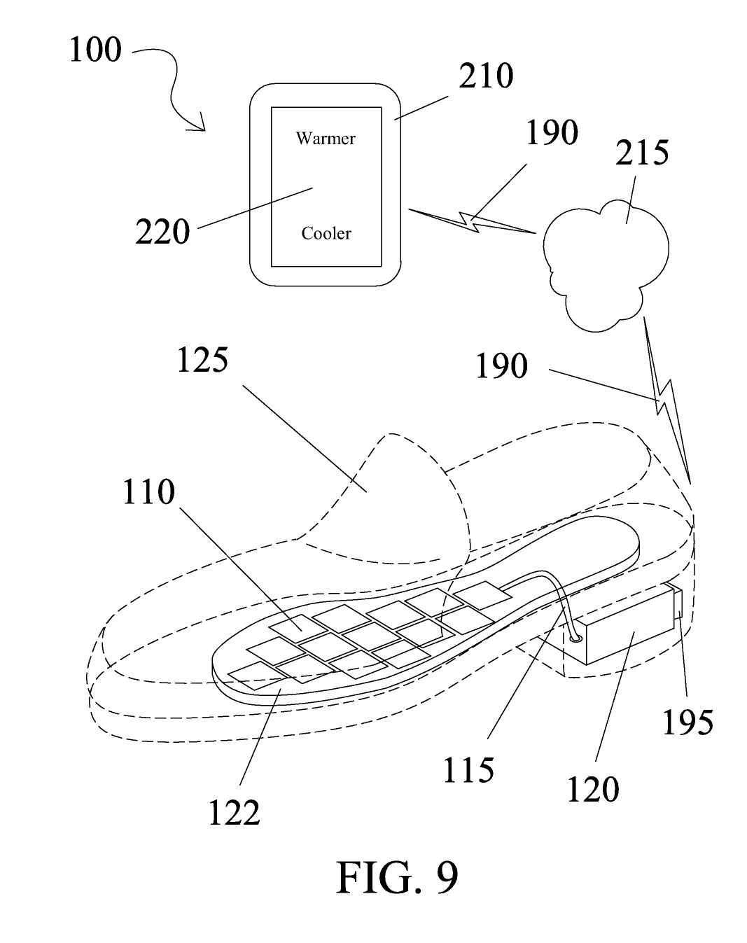

Now referring to FIG. 9, a wireless appliance 210 such as cellphone, smartphone, BLACKBERRY, internet enabled computer, etc. to control shoe 125 by sending the appropriate commands through a network 215 such as the Internet. In the embodiment shown, the user selects warmer or cooler, rather than selecting a specific temperature. Of course either embodiment could use a precise temperature selection or warmer/cooler type selection.

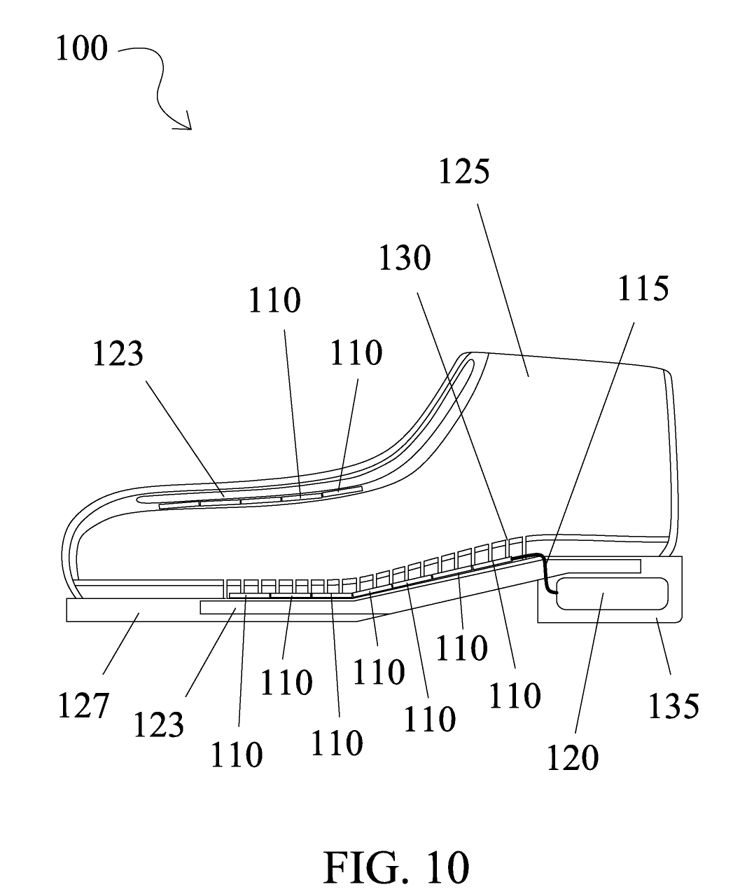

Referring to FIG. 10, a temperature controllable shoe 100 is shown having a plurality of peltier chips along an upper portion of shoe 125 as well as on sole portion. A heat sink 123 is provided to thermally conduct the unwanted thermal energy away from the interior of shoe 125. Although shown only on the top and bottom of shoe 125, peltier chips may be placed anywhere around the perimeter of shoe 125 to provide enhanced temperature control.

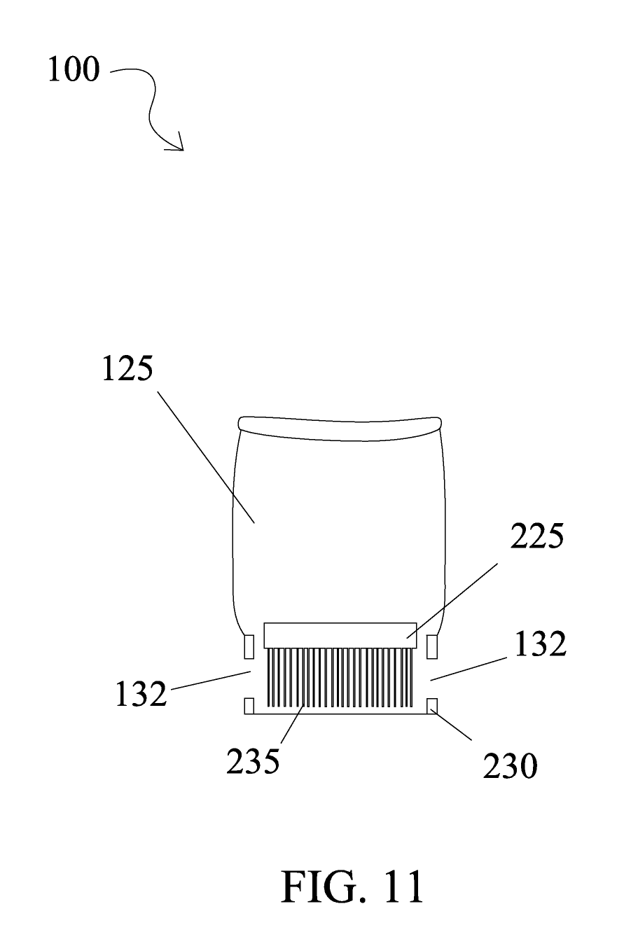

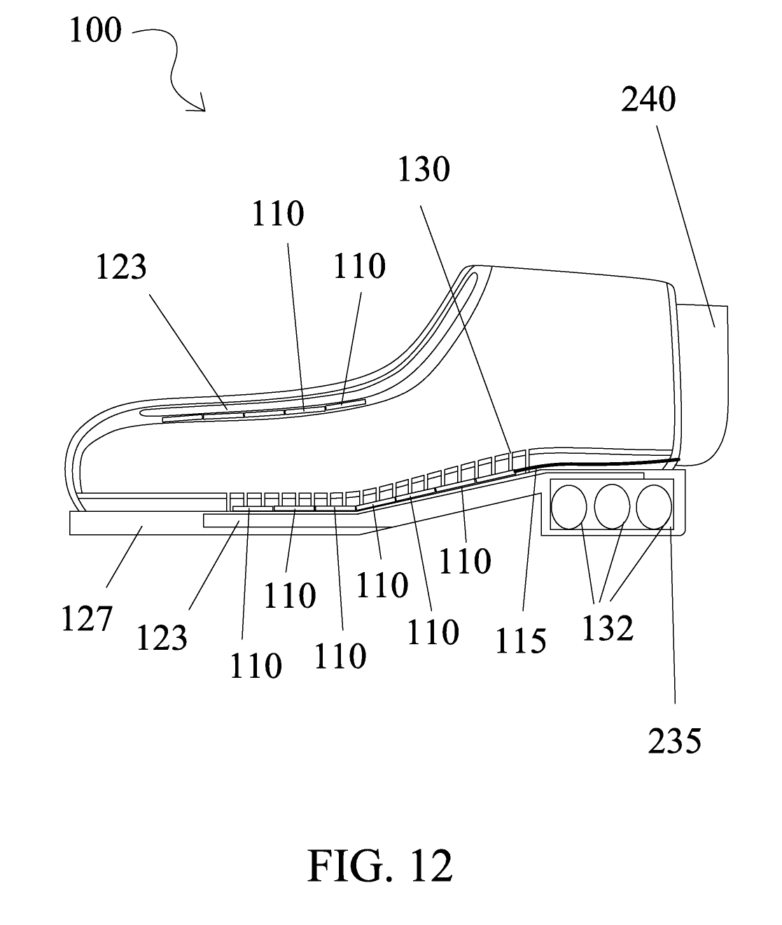

Now referring to FIGS. 11 and 12, temperature controllable shoe 100 is shown having an enhanced heat transfer block 225 with heat transfer fins 235 to further dissipate heat. Ventilation holes 132 are disposed within heel 230 to provide airflow. In this embodiment, a battery pack 240 is disposed along the quarter of shoe 125.

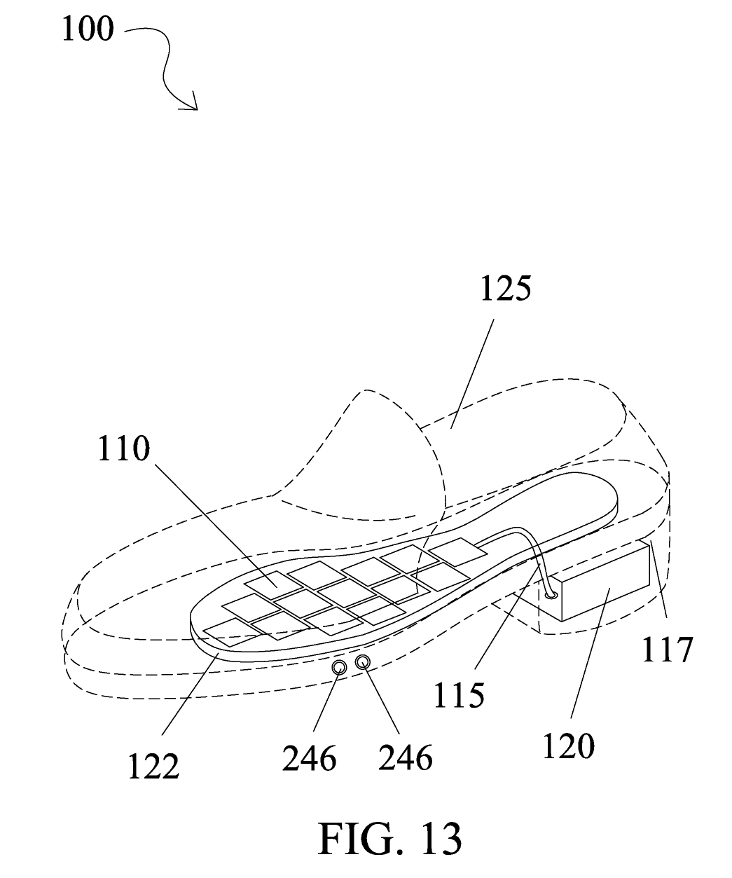

Referring to FIG. 13, temperature controllable shoe 100 is shown having indicator lights 246 to allow the user to visually ascertain the state of shoe 125. A blue light indicates a cooling state and a red light indicates a warming state. Of course other light schemes may be used including a power indicator light or non-colored lights.

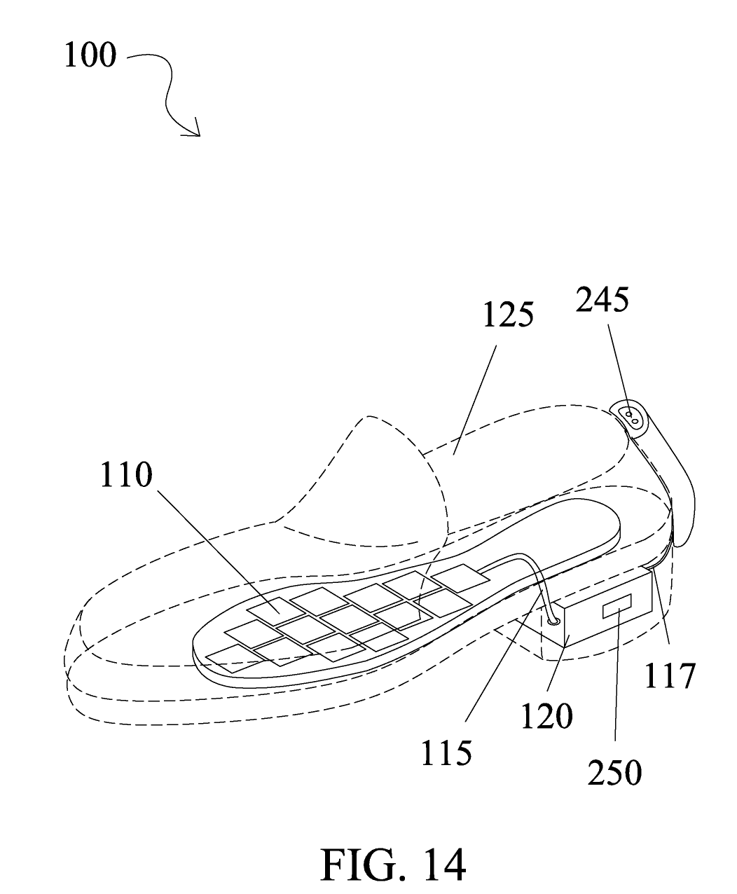

Referring now to FIG. 14, temperature controllable shoe 100 is shown having a power switch 250 disposed on a heel portion. In this embodiment, no remote control is needed. Additionally, temperature control switches are provided (not shown) to control the temperature as is known in the art.

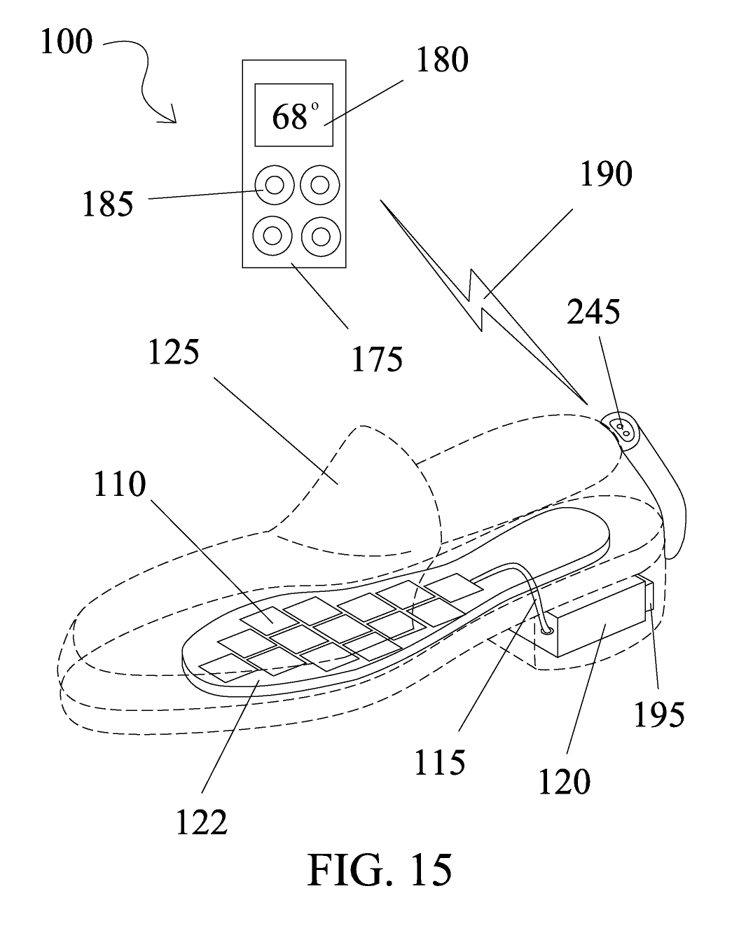

Referring to FIG. 15, temperature controllable shoe 100 is shown having remote control 175 and indicator lights 245 along a heel quarter portion of shoe 125. Remote control 175 may be a key chain bob or other small device as is known in the art.

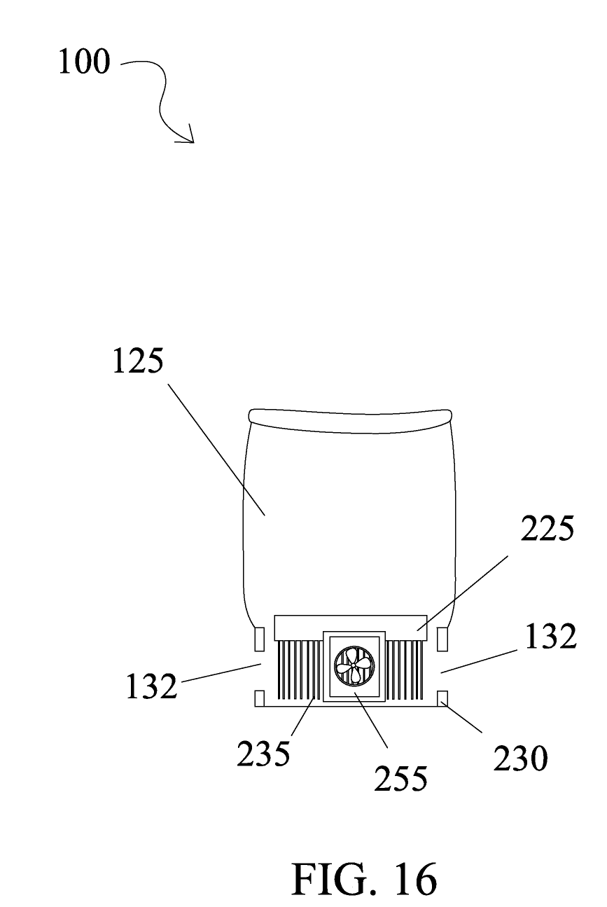

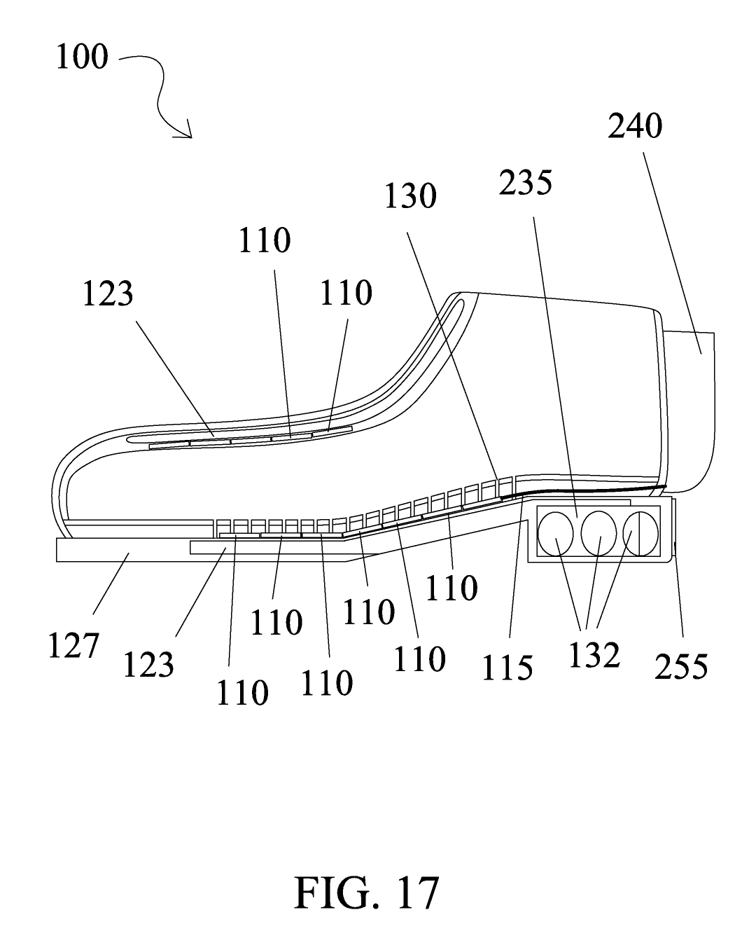

Referring to FIGS. 16 and 17, temperature controllable shoe 100 is shown having a fan 255 disposed in heel 230 to further enhance the thermal properties of heat transfer fins 235.

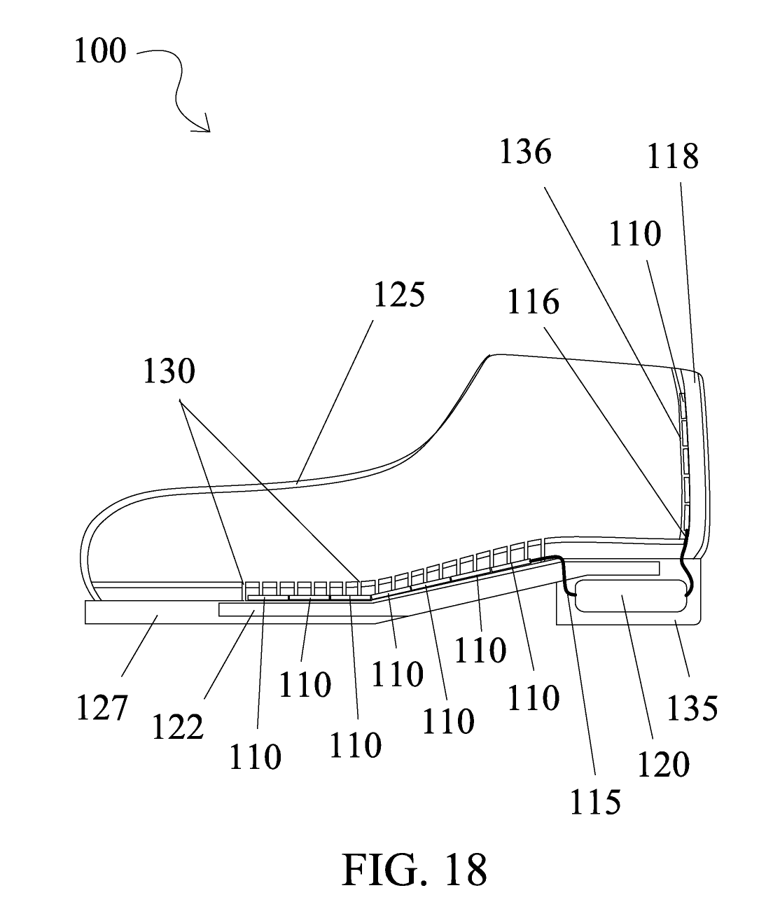

Referring now to FIG. 18, temperature controllable shoe 100 is shown having a plurality of peltier chips 110 disposed along the back quarter portion of shoe 125 to further enhance the temperature regulation of shoe 125. A heat sink 118 is also disposed along an outer portion of peltier chips 110 to dissipate heat with padding material 136 placed between peltier chips 110 and the inner portion of shoe 125 in order to protect the user from temperature extremes of peltier chips 110.

By controlling the direction of current flowing through the peltier chips, they can be made to heat or cool the shoes. A heat sink is needed to dissipate the unwanted heat allowing the desired thermal properties to be applied to the inner portion of the shoe thereby controlling the temperature of the shoe.

Although the instant invention has been described in relation to particular embodiments thereof, many other variations and modifications and other uses will become apparent to those skilled in the art.

What is claimed is:

1. A temperature controllable shoe comprising:
a shoe portion;
a plurality of peltier chips disposed along an inner portion of said shoe portion;
a power source in electrical communication with said plurality of peltier chips wherein when energized said peltier chips will produce either heating or cooling depending on a selection made;
a heat sink in thermal contact with a back portion of said plurality of peltier chips whereby unwanted heat is dissipated in use;
a protective barrier portion covering an inner facing portion of said plurality of peltier chips whereby a user is protected from temperature extremes; and
an electrical control in electrical communication with said plurality of peltier chips whereby a user controls the temperature within said shoe.

2. The temperature controllable shoe according to claim 1 further comprising a temperature sensing device disposed within said shoe wherein a temperature inside of said shoe is detected;
a thermostat that controls said plurality of peltier chips whereby said plurality of peltier chips are controllable within a selected temperature range.

3. The temperature controllable shoe according to claim 1 further comprising;
a receiver disposed within said shoe and in electrical communication with said plurality of peltier chips; and
a wireless remote control unit in electrical communication with said receiver whereby the temperature of said shoe is adjusted.

4. The temperature controllable shoe according to claim 1 further comprising at least one indicator light disposed on said shoe whereby a user is visually alerted to a status of said shoe.

5. The temperature controllable shoe according to claim 1 wherein said power source is disposed within a heel portion of said shoe.

6. The temperature controllable shoe according to claim 1 where said power source is disposed within a wearable container; said wearable container having an attachment means for wearing said container.

7. The temperature controllable shoe according to claim 6 wherein said attachment means is an elastic band.

8. The temperature controllable shoe according to claim 1 wherein said heat sink is disposed in a heel portion of said shoe.

9. The temperature controllable shoe according to claim 8 further comprising a fan disposed on an outer portion of said heat sink;
said fan being in electrical communication with said power source whereby said fan enhances the thermal exchange properties of said heat sink when energized.

10. The temperature controllable shoe according to claim 3 whereby said wireless remote control unit is an Internet enabled device.

11. A temperature controllable shoe comprising:
a shoe portion having an inner portion;
a plurality of peltier chips disposed along at least a portion of said inner portion;
an electrical power means for energizing said plurality of peltier chips;
a control means for controlling a temperature within said inner portion; and
a heat transfer means for dissipating unwanted heat within said plurality of peltier chips.

12. The temperature controllable shoe according to claim 11 wherein said electrical power means is a battery in electrical communication with said plurality of peltier chips.

13. The temperature controllable shoe according to claim 12 wherein said control means is a wireless control unit.

14. The temperature controllable shoe according to claim 11 wherein said heat transfer means is a heat sink in thermal contact with said plurality of peltier chips.

15. The temperature controllable shoe according to claim 11 further comprising at least one indicator light in electrical communication with said electrical power means and said plurality of peltier chips whereby a status of said shoe is visually displayed.
